(19) United States
(12) Patent Application Publication
(10) Pub. No.: US 2006/0017982 A1
(43) Pub. Date: Jan. 26, 2006

(54) Apparatus and method of limiting facsimile usage on an MFP

(75) Inventors: Gary Lin Gaebel, Vancouver, WA (US); Sara Lynn Leslie, Washougal, WA (US)

Correspondence Address: ROBERT D. VARITZ, 4915 S.E. 33RD PLACE, PORTLAND, OR, 97202, US

(73) Assignee: Sharp Laboratories of America, Inc.

(21) Appl. No.: 10/898,481

(22) Filed: Jul. 22, 2004

(51) Int. Cl. H04N 1/00

(52) U.S. Cl. 358/400; 358/403

(57) ABSTRACT

A method of controlling usage of a facsimile machine includes providing listings of authorized entries in a category of action items; comparing an input action item for a facsimile with the list of authorized entries for the category of action items; determining if the input action item is authorized; and if the action item is taken from the group of authorized entries, allowing processing of the facsimile; and if the action item is not taken from the group of authorized entries, prohibiting processing of the facsimile.

### FIELD OF THE INVENTION

This invention relates to facsimile machines and multi-function peripherals (MFPs) devices having a facsimile controller board, and specifically to an apparatus and method of controlling usage of a facsimile machine.

### BACKGROUND OF THE INVENTION

The problem solved by this invention is unauthorized use of a facsimile machine. Unauthorized facsimiles for purposes of this disclosure include: (1) large documents: a document which is too large may include documents which contain various color graphics or images, assuming use of a color facsimile, or documents containing many pages; (2) documents of a restricted type, such as color documents: monochrome documents are cheaper to print; (3) documents with an undesirable text content, e.g., documents which require optical character recognition (OCR) software to detect the textual contents of the document; (4) documents sent to an unauthorized phone number, e.g., a 900 number, or an area code which requires a long distance call; and (5) documents sent at inappropriate times, e.g., a document sent after business hours.

Most often, a phone switch box, or a local telephone service provider, controls facsimile usage. For example, one prior art solution to the problem stated above is to restrict a phone line to only local calls. Thus, sending a long distance facsimile is prohibited, however, an obvious problem with this prior art solution is that, when it is necessary to send a facsimile to a number which is a long distance call, a different facsimile machine must be used.

Some of the prior art solutions, described later herein, depend on the number of MFPs or facsimile machines in a network. For example, many retail businesses offer facsimile machine service to the public. In this scenario, the facsimile machine is typically located behind the counter away from the customer. Thus, a human operator dials the telephone number and feeds in the document to be sent, and is thus able to control facsimile usage.

In an office environment, particularly in smaller offices, monitoring facsimile machine usage is achieved by creating facsimile usage rules that employees are mandated to follow, which, of course, is solely dependent on employee honesty.

In a large office environment, central monitoring stations are used to monitor facsimile usage. For example, U.S. Pat. No. 6,320,948 B1, to Heilmann et al., granted Nov. 20, 2001, for Telephony security system, describes a central monitoring system configured to monitor outgoing telephone traffic. This system is able to detect facsimile usage which may be considered as questionable or unauthorized.

U.S. Pat. No. 6,279,038 B1, to Hogan et al., granted Aug. 21, 2001, for Client interface, describes a system and method for processing telephone calls and providing enhanced services wherein the call processing system includes a network control processor for controlling the processing and routing of the calls and for providing enhanced features, and a matrix switch for routing calls from an originating location to a terminating location. Operator consoles may be provided for operator assistance to the caller. The network control processor includes a central message processor that receives call data, determines the type of call, determines the processing required, and determines whether operator assistance is required.

U.S. Pat. No. 6,249,575 B1, to Heilmann et al., granted Jun. 19, 2001, for Telephony security system, describes a system and method of telephony security for controlling and logging access between an enterprise's end-user stations and their respective circuits into the public switched telephone network (PSTN). A security policy, i.e., a set of security rules, are defined for each of the extensions, the rules specifying actions to be taken based upon at least one attribute of the call on the extension. Calls are detected and sensed on the extensions to determine attributes associated with each call. Actions are then performed on selected calls based upon their attributes in accordance with the security rules defined for those extensions.

U.S. Pat. No. 5,999,274, to Lee et al., granted Dec. 7, 1999, for Apparatus and method for transmitting facsimile data, describes a system for transmitting data in real-time over a standard digital data network, or an analog network, whereby the facsimile data is sent in data packets on the digital data network. A number in an area being dialed by a facsimile device is monitored to determine whether the number is either a local number, inter-lata number, intra-lata number or a long distance number and whether the area is being serviced by the digital data network.

U.S. Pat. No. 5,852,785, to Bartholomew et al., granted Dec. 22, 1998, for Secure access telephone extension system and method in a cordless telephone system, and U.S. Pat. No. 5,530,737, to Bartholomew et al., granted Jun. 25, 1996, for Secure access telephone extension system and method, describe a method and system for conducting secure power line carrier communications in full duplex over the power lines of a building. Matching of random security codes may be initiated by the user, which may be used to prohibit unauthorized access to the central office line, particularly for long distance calls, and to prevent eavesdropping by other users in the same building with similar line carrier telephone extension products.

### SUMMARY OF THE INVENTION

A method of controlling usage of a facsimile machine includes providing listings of authorized entries in a category of action items; comparing an input action item for a facsimile with the list of authorized entries for the category of action items; determining if the input action item is authorized; and if the action item is taken from the group of authorized entries, allowing processing of the facsimile; and if the action item is not taken from the group of authorized entries, prohibiting processing of the facsimile.

It is an object of the invention to provide a facsimile device wherein limitations may be imposed on facsimile uses independent of phone line configuration.

It is another object of the invention to provide a facsimile device wherein limitations may be imposed on facsimile uses independent of a local area network.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWING

FIG. 1 is a flow-chart depiction the software of the invention.

FIG. 2 is a block diagram of the system of the invention.

### DETAILED DESCRIPTION OF THE PREFERRED EMBODIMENT

This invention comprises a facsimile controller board configured to run software which allows predetermined limitations to facsimile usage unique to the facsimile device, whether such device be a dedicated facsimile machine, a facsimile card in a multifunction peripheral (MFP), or a direct computer facsimile device, in which the controller board and software is installed. The facsimile limitations may be configurable by an administrator using a configuration protocol, from the front panel of the MFP, or remotely via protocols such as HTTP, when the MFP is connected to a network. Facsimile limitations may be set for both incoming and outgoing facsimiles. The facsimile controller board is configurable to limit facsimiles by individual user profiles, group profiles, or all users. Table 1 below illustrates limitations on facsimile usage wherein limitations, also referred to herein as categories of action items, include authorized entries, or which may also be configured by un-authorized entries.

TABLE 1

| Configuration | Limitations | Comment |
|---|---|---|
| Incoming | Unauthorized phone | entire number or just first or |
| facsimiles | number of sender | last few numbers |
| | Inappropriate text content | may require OCR software |
| | Color documents | |
| Document size | large documents, or | |
| | | documents having color and |
| | | OCR requirements |
| | Prohibit all incoming | for send-only devices |
| | facsimiles | |
| | Time of day | only during normal business |
| | | hours |
| Outgoing | User profile restrictions | password requirement |
| facsimiles | Unauthorized phone | entire number or just first or |
| | numbers of receiver | last few numbers |
| | Inappropriate text content | OCR/color |
| | Document size | large documents, or |
| | | documents having color and |
| | | OCR requirements |
| | Time of day | only during normal business |
| | | hours; or, scan/store and send |
| | | after long distance rates go |
| | | down |

Many user accounts may be available on a given MFP. In order for a user to transmit a facsimile, a user is required to enter a user name and a password before the facsimile may be sent. If open access is provided for all users, the user name/password requirement is not used.

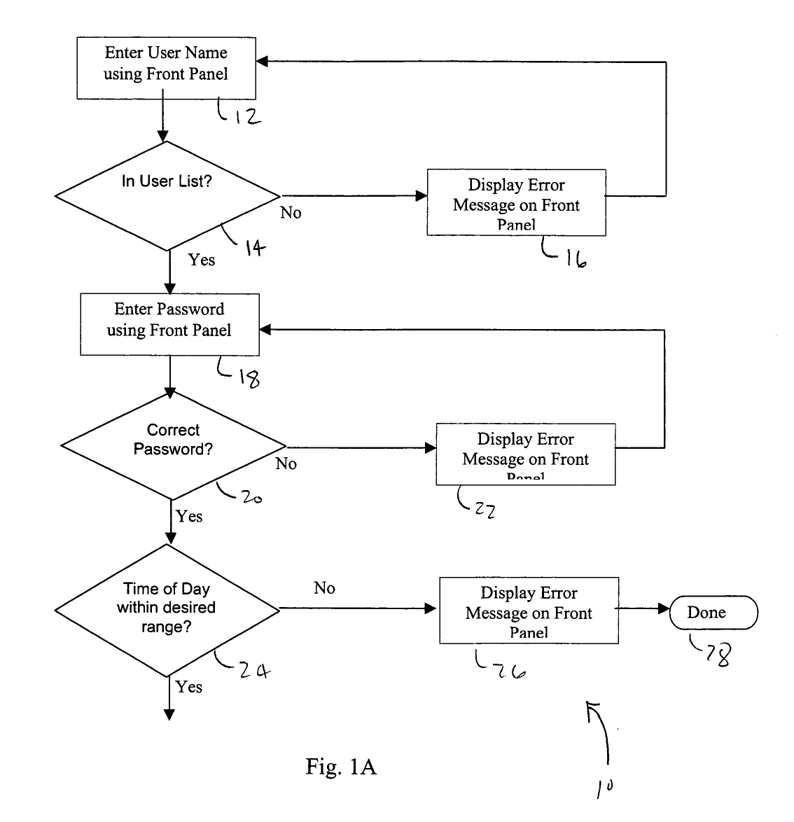

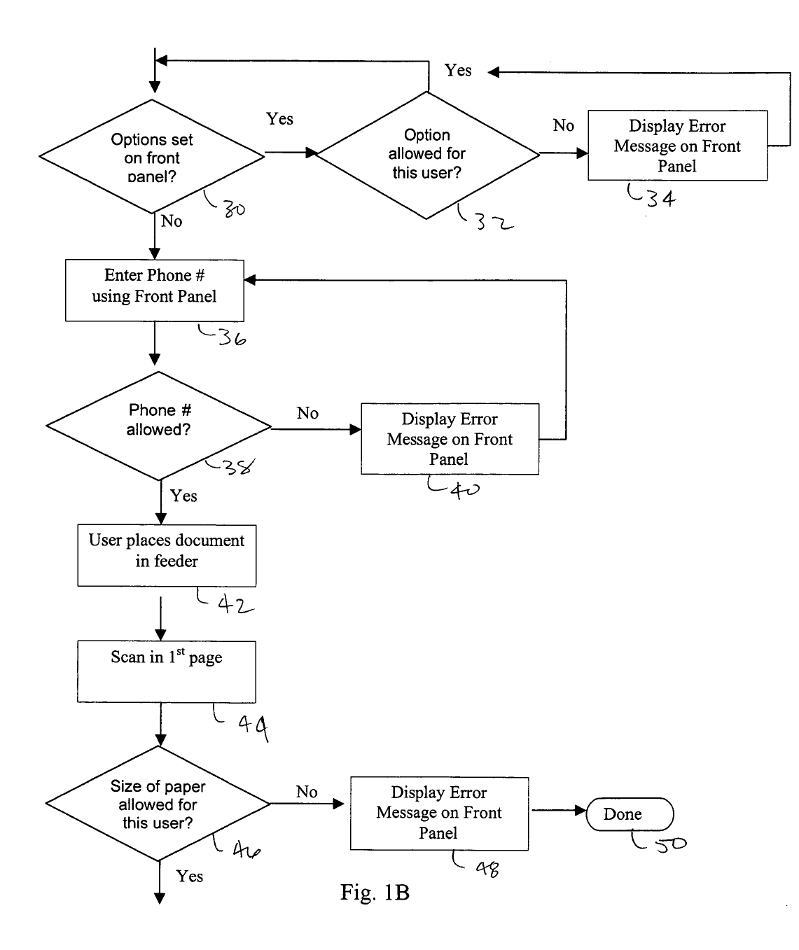

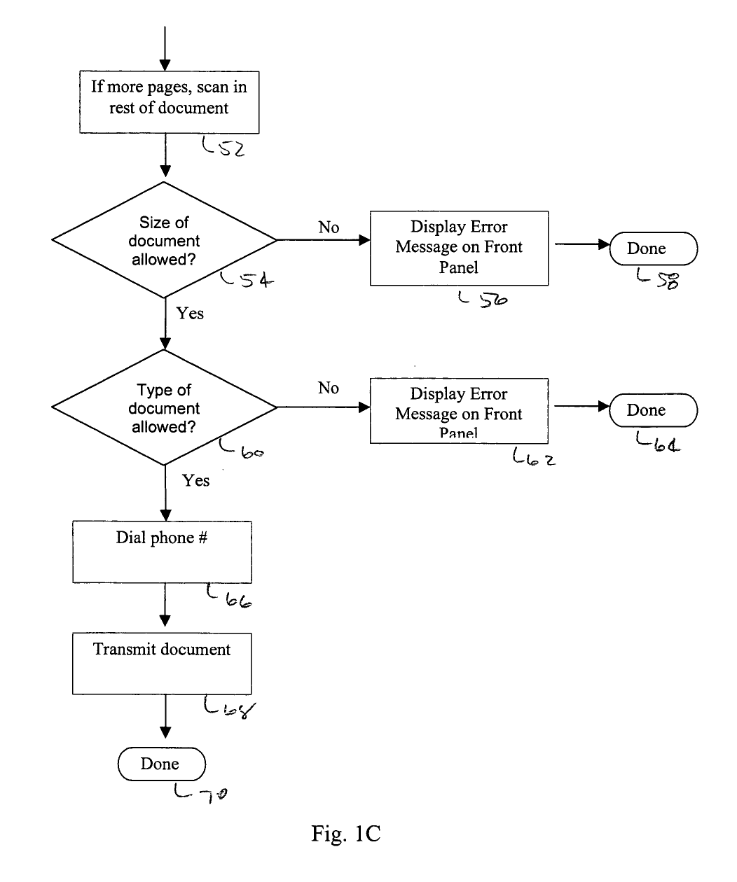

FIG. 1 is a flow chart of the facsimile controller board software of the invention for transmission of a document, depicted generally at 10, and spread over three plates for purposes of clarity. A similar protocol is followed for receipt of a facsimile, the primary difference being that the facsimile sender's phone number is used as the key to the list of allowed options. The basic concept of the method of the invention includes providing listings of authorized entries in a category of action items; comparing an input action item for a facsimile with the list of authorized entries for the category of action items; determining if the input action item is authorized; and if the action item is taken from the group of authorized entries, allowing processing of the facsimile; and if the action item is not taken from the group of authorized entries, prohibiting processing of the facsimile.

Initially, a user enters the user's name using the front panel of the device, 12. The device queries its list of authorized users, 14, to determine if the user is on the list. If the user is not on the list, an error message is displayed, 16. If the user is on the list of authorized users, the user is prompted for the user's password 18. The password is checked against the user list passwords 20, and if incorrect, an error message 22 is displayed. If the password is correct, The device determines whether the user is authorized to use the devise at the current time of day, 24, and if not, an error message is displayed 26, and the use terminates, 28. Referring now to FIG. 1B, the device checks to determine if there exist user-selected options, 30, and if so, determines whether the user is authorized to use the user-selected options, 32. If so, the process continues; if not, an error message is displayed, 34, and the user is required to delete the selected options, or to select authorized user-selected options before continuing.

The user is prompted to enter the phone number to which the facsimile is to be sent, 36. The device checks its list of authorized phone numbers to determine if the facsimile is allowed to send to the phone number, or, the device checks a list of un-authorized phone numbers to determine if the number is not authorized, 38. An error message is generated if the selected phone number is not authorized, 40.

Once the use of the device has been approved, the user is instructed to place the document in the device, 42, and the first page of the document is scanned, 44. The device determines if the document is of a type which is approved for transmission, beginning with determining whether the paper size is authorized, 46. If the paper size is not authorized, an error message is displayed, 48, and the job terminates, 50.

Turning now to FIG. 1C, if the paper size is authorized, the remainder of the document is scanned, 52. The device, after scanning the entire document, determines whether the document size is authorized, 54, and if not, generates an error message, 56, and terminates the process, 58. If the document is of an authorized size, the device next determines whether the document is of an authorized type, e.g., does not contain graphics, does not require OCR capabilities, etc., 60. If not, an error message is generated, 62, and the process terminated, 64.

After all the criteria for authorized use have been considered and approved, the device dials the phone number for the receiving station, 66, transmits the document, 68, and terminates the process.

An administrator configures the system of the invention to define limits for individual users, or groups of users. This may be done using a front panel on a facsimile machine or MFP. It may also be done with network controls, e.g., web page(s) generated by the facsimile machine, MFP and the facsimile controller board of the invention, and which provides a means to install setting on the facsimile controller board. The configuration of the method of the invention includes: (1) adding or removing users to the list of people who can send documents from the facsimile machine; (2) changing a user's password; (3) create or delete user groups; (4) add users to, or remove them from, a group; (5) add or remove phone numbers from which the facsimile machine is able to receive, phone numbers may include the full phone number or only the first or last few digits; (6) if document size is used as a limit, select how it is to be measured, generally from a list of several choices; (7) if document type is used as a limit, select which types will be used, generally from a list of several choices; (8) errors handling: select from a list of error messages, e.g., error message displayed on front panel; save document being transmitted on disk; send document to administrator over the network; save type of error and user/group/phone number; and (9) create a list of words or phrases to search for, and handling method, if found.

For any user or group, outbound facsimile transmissions may be limited by: (1) time of day user could use the facsimile machine; (2) size of document; (3) type of document; (4) phone numbers allowed to send to; and (5) restricted words/phrases.

For any phone number the machine receives from, limits may be provided, such as: (1) time of day machine would accept incoming facsimiles; (2) size of document; (3) type of document; and (4) restricted words/phrases.

In the event that a document is detected which contains restricted text content, e.g., such that the use of optical character recognition (OCR) software is required to render the document sendable, the words or phrases within the document may be compared to a previously administer-created list. If a document contains words or phrases from this list, the document is flagged, and appropriate actions taken, for example, the administrator might create the following list of undesirable text:

TABLE 2

| Search for Text | Action if Text Found Within Document |
|---|---|
| confidential | Do not send/retrieve fax; forward document to |
| | administrator with user name and date/time. |
| do not copy | Do not send/retrieve fax; forward document to |
| | administrator with user name and date/time. |
| security | Send user name and date/time to administrator |
| vixen | Send user name and date/time to administrator |

Thus, an apparatus and method of limiting facsimile usage on an MFP has been disclosed. It will be appreciated that further variations and modifications thereof may be made within the scope of the invention as defined in the appended claims.

We claim:

1. A method of controlling usage of a facsimile machine comprising:
providing listings of authorized entries in a category of action items;
comparing an input action item for a facsimile with the list of authorized entries for the category of action items;
determining if the input action item is authorized; and
if the action item is taken from the group of authorized entries, allowing processing of the facsimile; and
if the action item is not taken from the group of authorized entries, prohibiting processing of the facsimile.

2. The method of claim 1 wherein the categories of action items includes user identification; user password; time of day; phone number; paper size; document size; and document type.

3. The method of claim 1 wherein, for an incoming facsimile, the categories of action items includes unauthorized phone number of sender; inappropriate text content; color documents; document size; prohibit all incoming facsimiles; and time of day.

4. The method of claim 1 wherein, for an outgoing facsimile, the categories of action items includes user profile restrictions; unauthorized phone numbers of receiver; inappropriate text content; document size; and time of day.

5. The method of claim 1 which includes an administrator configuration protocol including:
adding or removing users to the list of people who can send documents from the facsimile machine;
changing a user's password;
creating and deleting user groups;
adding users to and removing users from a group;
adding and removing phone numbers from which the facsimile machine is able to receive;
selecting how to measure document size;
selecting authorized document types;
selecting an appropriate error message; and
creating a list of words or phrases to search for when identifying an unauthorized document.

6. The method of claim 1 which includes an administrator configuration protocol including: for any user or group, limiting outbound facsimile transmissions by:
time of day;
size of document;
type of document;
phone numbers allowed to send to; and
restricted words/phrases.

7. The method of claim 1 which includes an administrator configuration protocol including: for any phone number the machine receives from, limiting inbound facsimile reception by:
time of day;
size of document;
type of document; and
restricted words/phrases.

8. A method of controlling usage of a facsimile machine comprising:
providing listings of authorized entries in a category of action items, wherein the categories of action items includes user identification; user password; time of day; phone number;
paper size; document size; and document type;
comparing an input action item for a facsimile with the list of authorized entries for the category of action items;
determining if the input action item is authorized; and
if the action item is taken from the group of authorized entries, allowing processing of the facsimile; and
if the action item is not taken from the group of authorized entries, prohibiting processing of the facsimile.

9. The method of claim 8 wherein, for an incoming facsimile, the categories of action items includes unauthorized phone number of sender; inappropriate text content; color documents; document size; prohibit all incoming facsimiles; and time of day.

10. The method of claim 8 wherein, for an outgoing facsimile, the categories of action items includes user profile restrictions; unauthorized phone numbers of receiver; inappropriate text content; document size; and time of day.

11. The method of claim 8 which includes an administrator configuration protocol including:
adding or removing users to the list of people who can send documents from the facsimile machine;
changing a user's password;
creating and deleting user groups;
adding users to and removing users from a group;
adding and removing phone numbers from which the facsimile machine is able to receive;
selecting how to measure document size;
selecting authorized document types;
selecting an appropriate error message; and
creating a list of words or phrases to search for when identifying an unauthorized document.

12. The method of claim 8 which includes an administrator configuration protocol including: for any user or group, limiting outbound facsimile transmissions by:
time of day;
size of document;
type of document;
phone numbers allowed to send to; and
restricted words/phrases.

13. The method of claim 8 which includes an administrator configuration protocol including: for any phone number the machine receives from, limiting inbound facsimile reception by:
time of day;
size of document;
type of document; and
restricted words/phrases.
